(19) United States
(12) Patent Application Publication
(10) Pub. No.: US 2004/0010069 A1
(43) Pub. Date: Jan. 15, 2004

(54) Rubber compositions and methods for improving the mooney scorch value and cure rate

(75) Inventors: Sung W. Hong, Cheshire, CT (US); Peter K. Greene, Goshen, CT (US)

Correspondence Address: Kenneth D. Tremain, Crompton Corporation, Benson Road, Middlebury, CT, 06749, US

(73) Assignee: UNIROYAL CHEMICAL COMPANY, INC.

(21) Appl. No.: 10/185,602

(22) Filed: Jun. 27, 2002

(51) Int. Cl. C08K 3/04

(52) U.S. Cl. 524/495

(57) ABSTRACT

A rubber composition is disclosed wherein the rubber composition contains at least (a) a rubber component; (b) a carbon black filler; (c) a thiuram disulfide accelerator having a molecular weight of at least about 400 and (d) an effective amount of an activator for the thiuram disulfide accelerator. The compositions may also include suitable amounts of other ingredients such as antiozonants, antioxidants, etc.

### BACKGROUND OF THE INVENTION

1. Technical Field

This invention relates generally to rubber compositions and a method for improving the Mooney Scorch value and cure rate of rubber composition. The rubber compositions are particularly useful for tire treads and other tire components in a vehicle, e.g., bicycle, motorbike, passenger automobiles and trucks.

2. Description of the Related Art

The external components of modern tires such as, for example, tire treads, sidewall and linear compounds, must meet performance standards which require a broad range of desirable properties. Generally, three types of performance standards are important in tread compounds. They include good wear resistance, good traction and low rolling resistance. Accordingly, major tire manufacturers have developed tire treads which provide lower rolling resistance for improved fuel economy and better skid/traction for a safer ride. Thus, rubber compositions suitable for, e.g., tire treads, should exhibit not only desirable strength and elongation, particularly at high temperatures, but also good cracking resistance, good abrasion resistance, desirable skid resistance, low tangent delta values at 60° C. and low frequencies for desirable rolling resistance of the resulting treads. Additionally, a high complex dynamic modulus is necessary for maneuverability and steering control. A high Mooney Scorch value is further needed for processing safety.

In addition to the external tire components, rubber compositions suitable for internal components of a tire such as, for example, carcass, belt, and apex are desirably cured faster to match the cure rate of the external components.

In general, rubber compositions in which a carbon black filler is compounded into a rubber component, e.g., natural rubber, polybutadiene, polyisoprene or styrene-butadiene copolymer rubber, are widely used as rubber materials for such articles as, for example, tires. However, the need for increased productivity requires an increase in cure rate.

In order to increase the cure rate, secondary accelerators such as, for example, low molecular weight thiuram disulfides, e.g., tetramethyl thiuram monosulfide or tetramethyl thiuram disulfide, and diphenyl guanidine (DPG), have been added to the rubber compositions. However, problems are associated with the use of these secondary accelerators. For example, low molecular weight thiuram disulfides are known to generate nitrosamines resulting in worldwide environmental concerns. Also, the use of low molecular weight thiurams and/or DPG with polyalkylene oxides result in the rubber composition having a lower Mooney Scorch value during its manufacture thereby resulting in decreased processing time. Problems associated with a decreased processing time include, for example, precured compounds and rough surfaces on extruded parts. Additionally, diphenyl guanidine is typically employed in high amounts which result in the rubber compositions being more expensive to manufacture since more material must be used.

It would be desirable to provide a rubber composition which employs an accelerator that does not generate environmentally undesirable nitrosamine compounds. It would also be desirable to provide a rubber composition which has a decreased cure time and a higher Mooney Scorch value without sacrificing other physical properties, e.g., tangent delta value. This will allow for better processing of the rubber composition during its manufacture and improved productivity.

### SUMMARY OF THE INVENTION

In accordance with the present invention, a rubber composition is provided which comprises (a) a rubber component; (b) a carbon black filler; (c) a thiuram disulfide accelerator having a molecular weight of at least about 400 and (d) an effective amount of an activator for the thiuram disulfide accelerator.

Further in accordance with the present invention, a method for improving Mooney Scorch value and cure rate of a rubber composition is provided which comprises the step of forming a rubber composition comprising (a) a rubber component; (b) a carbon black filler; (c) a thiuram disulfide accelerator having a molecular weight of at least about 400 and (d) an effective amount of an activator for the thiuram disulfide accelerator.

The high molecular weight thiuram disulfide accelerators of the present invention, in addition to eliminating or substantially eliminating the formation of nitrosamines, have excellent curing characteristics such as cure rate and scorch safety without sacrificing other physical properties such as, for example, tangent delta value and stress-strain properties of the rubber compositions. Additionally, by employing an effective amount of an activator for the thiuram disulfide accelerator, lesser amounts of the high molecular weight thiuram disulfide can be used in forming the rubber compositions resulting in both a greater economical advantage by using less materials of the more expensive thiuram disulfide with the rubber compositions disclosed herein advantageously possessing an increased cure rate. In this manner, it has unexpectedly been discovered that an accelerator system having a desirable balance of low cost, no nitrosamine formation, excellent curing characteristics and scorch safety properties can be achieved.

The term “phr” is used herein as its art-recognized sense, i.e., as referring to parts of a respective material per one hundred (100) parts by weight of rubber.

### DESCRIPTION OF THE PREFERRED EMBODIMENTS

In accordance with the present disclosure, the rubber components for use in the rubber compositions of the present invention are based on highly unsaturated rubbers such as, for example, natural or synthetic rubbers. Representative of the highly unsaturated polymers that can be employed in the practice of this invention are diene rubbers. Such rubbers will ordinarily possess an iodine number of between about 20 to about 450, although highly unsaturated rubbers having a higher or a lower (e.g., of 50-100) iodine number can also be employed. Illustrative of the diene rubbers that can be utilized are polymers based on conjugated dienes such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example, styrene, alpha-methylstyrene, acetylene, e.g., vinyl acetylene, acrylonitrile, methacrylonitrile, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly (acrylonitrile-butadiene). Moreover, mixtures of two or more highly unsaturated rubbers with elastomers having lesser unsaturation such as EPDM, EPR, butyl or halogenated butyl rubbers are also within the contemplation of the invention.

Suitable carbon black fillers for use herein include any of the commonly available, commercially-produced carbon blacks known to one skilled in the art. Generally, those having a surface area (EMSA) of at least about 5 m²/g, preferably at least about 35 m²/g and most preferably at least about 200 m²/g are preferred. Surface area values used in this application are those determined by ASTM test D-3765 using the cetyltrimethyl-ammonium bromide (CTAB) technique. Among the useful carbon blacks are furnace black, channel blacks and lamp blacks. More specifically, examples of the carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which may be utilized include acetylene blacks and thermal blacks. Mixtures of two or more of the above blacks can be used in preparing the rubber compositions of the invention. Typical values for surface areas of usable carbon blacks are summarized in the following Table I.

TABLE I
Carbon Blacks

| ASTM | Surface Area |
|---|---|
| Designation | (m²/g) |
| (D-1765-82a) | (D-3765) |
| N-110 | 126 |
| N-234 | 120 |
| N-220 | 111 |
| N-339 | 95 |
| N-330 | 83 |
| N-550 | 42 |
| N-660 | 35 |

The carbon blacks utilized in the invention may be in pelletized form or an unpelletized flocculent mass. Preferably, for ease of handling, pelletized carbon black is preferred. The carbon blacks are ordinarily incorporated into the rubber composition in amounts ranging from about 10 to about 100 phr, preferably from about 30 to about 90 phr and most preferably from about 45 to about 85 phr.

The high molecular weight thiuram disulfides for use in the rubber composition of this invention as an accelerator advantageously have a weight average molecular weight (M_{w}) of at least about 400, preferably from about 500 to about 1250 and most preferably from about 800 to about 1000. Representative of these thiuram disulfides are those of the general formula

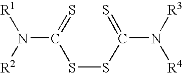

wherein R¹, R², R³ and R⁴ each are the same or different and are hydrocarbons containing, for example, from about 4 to about 30 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms. Specific thiuram disulfides include those in which R¹, R², R³ and R⁴ are independently selected to be t-butyl, pentyl, hexyl, cyclohexyl, heptyl, octyl, 2-ethylhexyl, nonyl, decyl, undecyl, dodecyl, stearyl, oleyl, phenyl, benzyl, tridecyl, tetradecyl, pentadecyl, hexadecyl, heptadecyl, octadecyl, nonadecyl, eicosanyl, and the like. It is particularly advantageous to employ a thiuram disulfide wherein R¹, R², R³ and R⁴ each are the same or different and are hydrocarbons containing a linear or branched alkyl group having between about 8 to about 18 carbon atoms. A particularly preferred thiuram disulfide for use herein is wherein R¹, R², R³ and R⁴ each possess between about 12 and about 14 carbon atoms.

Suitable activators for the foregoing high molecular weight thiuram disulfides include, but are not limited to, one or more polyoxyalkylene oxides, fatty acids such as stearic acid, zinc oxide and the like. Suitable polyalkylene oxides for use herein can be a polyalkylene oxide which is a polyether of the general formula X(R—O—)ₙH where R may be one or more of the following groups: methylene, ethylene, propylene or tetramethylene group; n is an integer of from 1 to about 50, preferably from about 2 to about 30 and most preferably from about 4 to about 20; and X is a non-aromatic starter molecule containing 1 to about 12 and preferably 2 to 6 functional groups. Representative of the polyalkylene oxides include, but are not limited to, dimethylene glycol, diethylene glycol, dipropylene glycol, trimethylene glycol, triethylene glycol, tripropylene glycol, polyethylene oxide, polypropylene oxide, polybutylene oxide and the like and mixtures thereof. A preferred activator for use herein is diethlyene glycol.

By employing an effective amount of the foregoing activators for the high molecular weight thiuram disulfides, the amount of thiuram disulfide necessary to form the rubber composition is reduced thereby providing an economical advantage. Also, the activators used herein and particularly diethylene glycol when employed in an effective amount advantageously decrease the cure time of the rubber compositions of this invention when added thereto. Accordingly, an effective amount of the activator(s) will ordinarily range from about 0.5 to about 10 phr, preferably from about 0.75 to about 5 phr and most preferably from about 1 to about 4 phr, while the thiuram disulfide is ordinarily present in the rubber composition of this invention in an amount ranging from about 0.05 to about 1 phr, preferably from about 0.10 to about 0.80 phr and most preferably from about 0.20 to about 0.60 phr.

The activator can be mixed at the master batch mixing or it can be added at the final stage mixing with accelerators and sulfur.

The rubber compositions of this invention can be formulated in any conventional manner known to one skilled in the art. Additionally, at least one other common additive can be added to the rubber compositions of this invention, if desired or necessary, in a suitable amount. Suitable common additives for use herein include fillers other than carbon black, vulcanizing agents, activators, retarders, antioxidants, plasticizing oils and softeners, reinforcing pigments, antiozonants, waxes, tackifier resins, coupling agents and the like and combinations thereof.

Examples of other fillers that can be incorporated into the rubber compositions of the present invention with the carbon black fillers include, but are not limited to, general inorganic fillers, e.g., calcium carbonate, clay, talc, diatomaceous earth, mica, alumina, aluminum sulfate, barium sulfate or calcium sulfate, silica, mixtures thereof and the like. The silica filler may be of any type that is known to be useful in connection with the reinforcing of rubber compositions. Representative of suitable silica fillers include, but are not limited to, silica, precipitated silica, amorphous silica, vitreous silica, fumed silica, fused silica, synthetic silicates such as aluminum silicates, alkaline earth metal silicates such as magnesium silicate and calcium silicate, natural silicates such as kaolin and other naturally occurring silicas and the like. Also useful are highly dispersed silicas having, e.g., BET surfaces of from about 5 to about 1000 m²/g and preferably from about 20 to about 400 m²/g and primary particle diameters of from about 5 to about 500 nm and preferably from about 10 to about 400 nm. These highly dispersed silicas can be prepared by, for example, precipitation of solutions of silicates or by flame hydrolysis of silicon halides. The silicas can also be present in the form of mixed oxides with other metal oxides such as, for example, Al, Mg, Ca, Ba, Zn, Zr, Ti oxides and the like. Commercially available silica fillers known to one skilled in the art include, e.g., those available from such sources as Cabot Corporation under the Cab—O—Sil® tradename; PPG Industries under the Hi-Sil and Ceptane tradenames; Rhodia under the Zeosil tradename and Degussa AG under the Ultrasil and Coupsil tradenames.

The rubber compositions of this invention are particularly useful when manufactured into articles such as, for example, tires, motor mounts, rubber bushings, power belts, printing rolls, rubber shoe heels and soles, rubber floor tiles, caster wheels, elastomer seals and gaskets, conveyor belt covers, hard rubber battery cases, automobile floor mats, mud flap for trucks, ball mill liners, windshield wiper blades and the like. Preferably, the rubber compositions of this invention are advantageously used in a tire as a component of any or all of the thermosetting rubber-containing portions of the tire. These include the tread, sidewall, and carcass portions intended for, but not exclusive to, a truck tire, passenger tire, off-road vehicle tire, vehicle tire, high speed tire, bicycle tire and motorcycle tire that also contain many different reinforcing layers therein. Such rubber or tire tread compositions in accordance with the invention may be used for the manufacture of tires or for the re-capping of worn tires.

### EXAMPLES

The following non-limiting examples are intended to further illustrate the present invention and are not intended to limit the scope of the invention in any manner.

### Comparative Examples A and B and Examples 1-4

Employing the ingredients indicated in Tables II and III (which are listed in parts per hundred of rubber by weight), several rubber compositions were compounded in the following manner: the ingredients indicated in Table II were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table III. The second pass is shorter and discharge temperatures generally run between 93-105° C.

TABLE II
PHASE I

| Comp. Ex./Ex. | A | B | 1 | 2 | 3 | 4 |
|---|---|---|---|---|---|---|
| SBR 1712¹ | 68.75 | 68.75 | 68.75 | 68.75 | 68.75 | 68.75 |
| SBR 1500² | 25.00 | 25.00 | 25.00 | 25.00 | 25.00 | 25.00 |
| CIS BR³ | 25.00 | 25.00 | 25.00 | 25.00 | 25.00 | 25.00 |
| N-234 | 55.00 | 55.00 | 55.00 | 55.00 | 55.00 | 55.00 |
| CARBON | | | | | | |
| BLACK⁴ | | | | | | |
| AROMATIC | 5.00 | 5.00 | 5.00 | 5.00 | 5.00 | 5.00 |
| OIL | | | | | | |
| ZINC OXIDE | 3.00 | 3.00 | 3.00 | 3.00 | 3.00 | 3.00 |
| STEARIC | 3.00 | 3.00 | 3.00 | 3.00 | 3.00 | 3.00 |
| ACID | | | | | | |
| MB-1: TOTAL | 184.75 | 184.75 | 184.75 | 184.75 | 184.75 | 184.75 |

¹Styrene-butadiene rubber available from Ameripol Synpol.
²Styrene-butadiene rubber available from Ameripol Synpol.
³Polybutadiene available from Goodyear Chemical.
⁴High surface area carbon black available from Cabot Corp.

TABLE III
PHASE II

| Comp. Ex./Ex. | A | B | 1 | 2 | 3 | 4 |
|---|---|---|---|---|---|---|
| MB-1⁵ | 184.75 | 184.75 | 184.75 | 184.75 | 184.75 | 184.75 |
| Delac NS⁶ | 1.00 | 1.00 | 1.00 | 1.00 | 1.00 | 1.00 |
| BENZYL | 0.25 | 0.00 | 0.00 | 0.00 | 0.00 | 0.00 |
| TUEX⁷ | | | | | | |
| ROYALAC | 0.00 | 0.50 | 0.40 | 0.40 | 0.25 | 0.25 |
| 150⁸ | | | | | | |
| Diethylene | 0.00 | 0.00 | 1.00 | 2.00 | 2.50 | 3.50 |
| Glycol | | | | | | |
| PVI⁹ | 0.10 | 0.10 | 0.10 | 0.10 | 0.10 | 0.10 |
| SULFUR¹⁰ | 1.50 | 1.50 | 1.50 | 1.50 | 1.50 | 1.50 |
| TOTAL | 187.60 | 187.85 | 189.75 | 189.75 | 190.10 | 191.10 |

⁵MB-1 is the batch provided as set forth in Table II.
⁶N-t-butyl-2-benzothiazole sulfenamide available from Uniroyal Chemical Company.
⁷Tetrabenzyl thiuram disulfide.
⁸Tetraalkyl (C₁₂-C₁₄) thiuram disulfide available from Uniroyal Chemical Company having an average molecular weight of 916.
⁹N(Cyclohexylthio)phthalamide available from Akrochem.
¹⁰Sulfur available from R.E. Carroll Co.

Results

The compounded stocks prepared above were then sheeted out and cut for cure. The samples were cured for the times and at the temperatures indicated in Table IV and their physical properties evaluated. The results are summarized in Table IV below. Note that in Table IV, cure characteristics were determined using a Monsanto rheometer ODR 2000 (1° ARC, 100 cpm): MH is the maximum torque and ML is the minimum torque. Scorch safety (tₛ2) is the time to 2 units above minimum torque (ML), cure time (t₅₀) is the time to 50% of delta torque above minimum and cure time (t₉₀) is the time to 90% of delta torque above minimum. Examples 1-4 illustrate a rubber composition within the scope of this invention. Comparative Examples A and B illustrate a rubber composition outside the scope of this invention.

TABLE IV
CURED PHYSICAL PROPERTIES

| | | | | | | |
|---|---|---|---|---|---|---|
| Comp. Ex./Ex. | A | B | 1 | 2 | 3 | 4 |

Cured Characteristics
obtained at
160° C.

| | | | | | | |
|---|---|---|---|---|---|---|
| ML (lb-in.) | 3.2 | 3.3 | 3.2 | 3.1 | 3.1 | 3.1 |
| MH (lb-in.) | 21.0 | 20.3 | 20.1 | 19.7 | 19.9 | 19.9 |
| Scorch safety t₅2 (min) | 7.5 | 7.5 | 7.6 | 6.4 | 5.9 | 5.0 |
| Cure time t₅₀ (min) | 9.8 | 9.9 | 9.8 | 8.1 | 7.6 | 6.6 |
| Cure time t₉₀ (min) | 14.7 | 14.5 | 13.9 | 11.3 | 11.0 | 9.1 |

It can be seen from the above data that the examples containing a high molecular weight thiuram disulfide and polyalkylene oxide as an activator (Examples 1-4) provide improved performance when compared to the examples containing a high molecular weight thiuram disulfide with no polyalkylene oxide activator present therein (Comparative Examples A and B). The cure rates for the rubber compositions were significantly faster for Examples 1-4 than that of Comparative Examples A and B while the scorch safety of the rubber compositions of the present invention significantly improved resulting in an economical cost advantage being realized.

### Comparative Examples C and D and Examples 5-9

Employing the ingredients indicated in Tables V and VI (which are listed in parts per hundred of rubber by weight), several rubber compositions were compounded in the following manner: the ingredients indicated in Table V were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table VI. The second pass is shorter and discharge temperatures generally run between 93-105° C.

TABLE V
PHASE I

| Comp.Ex./Ex. | C | D | 5 | 6 | 7 | 8 | 9 |
|---|---|---|---|---|---|---|---|
| SBR 1712 | 68.75 | 68.75 | 68.75 | 68.75 | 68.75 | 68.75 | 68.75 |
| SBR 1500 | 25.00 | 25.00 | 25.00 | 25.00 | 25.00 | 25.00 | 25.00 |
| CIS BR | 25.00 | 25.00 | 25.00 | 25.00 | 25.00 | 25.00 | 25.00 |
| N-234 CARBON | 55.00 | 55.00 | 55.00 | 55.00 | 55.00 | 55.00 | 55.00 |
| BLACK | | | | | | | |
| AROMATIC OIL | 5.00 | 5.00 | 5.00 | 5.00 | 5.00 | 5.00 | 5.00 |
| ZINC OXIDE | 3.00 | 3.00 | 3.00 | 3.00 | 3.00 | 3.00 | 3.00 |
| STEARIC ACID | 3.00 | 3.00 | 3.00 | 3.00 | 3.00 | 3.00 | 3.00 |
| MB-2: TOTAL | 184.75 | 184.75 | 184.75 | 184.75 | 184.75 | 184.75 | 184.75 |

TABLE VI
PHASE II

| | Comp. Ex/Ex. | | | | | | |
|---|---|---|---|---|---|---|---|
| | C | D | 5 | 6 | 7 | 8 | 9 |
| MB-2¹¹ | 184.75 | 184.75 | 184.75 | 184.75 | 184.75 | 184.75 | 184.75 |
| Delac NS | 1.00 | 1.00 | 1.00 | 1.00 | 1.00 | 1.00 | 1.00 |
| TUEX¹² | 0.25 | 0.00 | 0.00 | 0.00 | 0.00 | 0.00 | 0.00 |
| ROYALAC 150 | 0.00 | 0.00 | 0.25 | 0.25 | 0.25 | 0.25 | 0.25 |
| BENZYL TUEX | 0.00 | 0.25 | 0.00 | 0.00 | 0.00 | 0.00 | 0.00 |
| Diethylene Glycol | 0.00 | 0.00 | 3.00 | 3.00 | 4.00 | 4.50 | 5.00 |
| SULFUR¹³ | 1.50 | 1.50 | 1.60 | 1.80 | 1.60 | 1.60 | 1.60 |
| TOTAL | 187.50 | 187.50 | 190.60 | 190.80 | 191.60 | 192.10 | 192.60 |

¹¹MB-2 is the batch provided as set forth in Table V.
¹²Tetramethyl thiuram disulfide available from Uniroyal Chemical Co.
¹³Sulfur available from R.E. Carroll Co.

Results

The compounded stocks prepared above were then sheeted out and cut for cure. The samples were cured for the times and at the temperatures indicated in Table VII and their physical properties evaluated as in Examples 1-4 above. The results are summarized in Table VII below. Examples 5-9 illustrate a rubber composition within the scope of this invention. Comparative Examples C and D illustrate a rubber composition outside the scope of this invention.

TABLE VII
CURED PHYSICAL PROPERTIES

| | | | | | | | |
|---|---|---|---|---|---|---|---|
| Comp. Ex./Ex. | C | D | 5 | 6 | 7 | 8 | 9 |

Cured Characteristics
obtained at
150° C.

| | | | | | | | |
|---|---|---|---|---|---|---|---|
| ML (lb-in.) | 3.3 | 3.3 | 3.0 | 3.0 | 2.9 | 3.0 | 2.9 |
| MH (lb-in.) | 21.7 | 21.2 | 18.5 | 19.5 | 18.1 | 17.4 | 16.9 |
| Scorch safety t₅2 (min) | 4.9 | 7.1 | 6.0 | 5.7 | 5.3 | 4.9 | 4.6 |
| Cure time t₅₀ (min) | 6.3 | 9.3 | 7.4 | 7.1 | 6.6 | 6.1 | 5.8 |
| Cure time t₉₀ (min) | 9.2 | 14.0 | 10.2 | 9.9 | 9.4 | 8.6 | 7.9 |

It can be seen from the above data that the examples containing a high molecular weight thiuram disulfide and polyalkylene oxide as an activator (Examples 5-9) provide equivalent to improved performance when compared to the examples containing a low or high molecular weight thiuram disulfide with no polyalkylene oxide activator present therein (Comparative Examples C and D, respectively). The cure rates were comparable or faster for Examples 5-9 than that of Comparative Examples C and D while the scorch safety of the rubber compositions of the present invention was equivalent or improved resulting in an economical cost advantage being realized.

### Comparative Examples E and D and Examples 10-14

Employing the ingredients indicated in Tables VIII and IX (which are listed in parts per hundred of rubber by weight), several rubber compositions were compounded in the following manner: the ingredients indicated in Table VIII were added to an internal mixer and mixed until the materials are incorporated and thoroughly dispersed and discharged from the mixer. Discharge temperatures of about 160° C. are typical. The batch is cooled, and is reintroduced into the mixer along with the ingredients indicated in Table IX. The second pass is shorter and discharge temperatures generally run between 93-105° C.

TABLE VIII
PHASE I

| Comp. Ex./Ex. | E | F | 10 | 11 | 12 | 13 | 14 |
|---|---|---|---|---|---|---|---|
| SMR CV60¹⁴ | 100.00 | 100.00 | 100.00 | 100.00 | 100.00 | 100.00 | 100.00 |
| N220 CARBON | 50.00 | 50.00 | 50.00 | 50.00 | 50.00 | 50.00 | 50.00 |
| BLACK¹⁵ | | | | | | | |
| AROMATIC OIL | 6.00 | 6.00 | 6.00 | 6.00 | 6.00 | 6.00 | 6.00 |
| ZINC OXIDE | 3.00 | 3.00 | 3.00 | 3.00 | 3.00 | 3.00 | 3.00 |
| STEARIC ACID | 1.50 | 1.50 | 1.50 | 1.50 | 1.50 | 1.50 | 1.50 |
| MB-3: TOTAL | 160.50 | 160.50 | 160.50 | 160.50 | 160.50 | 160.50 | 160.50 |

¹⁴SMR CV60 Standard Malaysian Natural Rubber, Control Viscosity 60 +/− 5.
¹⁵High surface area carbon black available from Cabot Corp.

TABLE IX
PHASE II

| Comp. Ex./Ex. | E | F | 10 | 11 | 12 | 13 | 14 |
|---|---|---|---|---|---|---|---|
| MB-3¹⁶ | 160.50 | 160.50 | 160.50 | 160.50 | 160.50 | 160.50 | 160.50 |
| Delac NS | 1.00 | 1.00 | 1.00 | 1.00 | 1.00 | 1.00 | 1.00 |
| Tuex | 0.25 | 0.00 | 0.00 | 0.00 | 0.00 | 0.00 | 0.00 |
| ROYALAC 150 | 0.00 | 0.00 | 0.25 | 0.25 | 0.25 | 0.25 | 0.25 |
| BENZYL TUEX | 0.00 | 0.25 | 0.00 | 0.00 | 0.00 | 0.00 | 0.00 |
| Diethylene Glycol | 0.00 | 0.00 | 1.00 | 1.50 | 2.00 | 2.50 | 3.00 |
| PVI¹⁷ | 0.10 | 0.10 | 0.10 | 0.10 | 0.10 | 0.10 | 0.10 |
| SULFUR | 1.50 | 1.50 | 1.50 | 1.50 | 1.50 | 1.50 | 1.50 |
| TOTAL | 163.35 | 163.35 | 164.35 | 164.85 | 165.35 | 165.85 | 166.35 |

¹⁶MB-3 is the batch provided as set forth in Table VIII.
¹⁷N(cyclohexyl(thio)phthalamide available from Akrochem.

Results

The compounded stocks prepared above were then sheeted out and cut for cure. The samples were cured for the times and at the temperatures indicated in Table X and their physical properties evaluated as in Examples 1-4 above. The results are summarized in Table X below.

TABLE X
CURED PHYSICAL PROPERTIES

| | | | | | | | |
|---|---|---|---|---|---|---|---|
| Comp. Ex./Ex. | E | F | 10 | 11 | 12 | 13 | 14 |

Cured Characteristics
obtained at
150° C.

| | | | | | | | |
|---|---|---|---|---|---|---|---|
| ML (lb-in.) | 2.1 | 2.1 | 2.1 | 2.0 | 2.0 | 2.0 | 2.0 |
| MH (lb-in.) | 27.5 | 25.3 | 23.8 | 23.2 | 22.5 | 22.4 | 21.4 |
| Scorch safety t₅2 (min) | 5.3 | 8.0 | 7.6 | 6.8 | 5.4 | 4.5 | 4.0 |
| Cure time t₅₀ (min) | 6.2 | 9.2 | 8.9 | 8.1 | 6.4 | 5.4 | 4.9 |
| Cure time t₉₀ (min) | 8.7 | 13.0 | 12.2 | 11.5 | 8.8 | 7.9 | 6.7 |
| Mooney Scorch | | | | | | | |
| (MS at 135° C.) | | | | | | | |
| 3 Pt. Rise Time (min) | 16.6 | 26.1 | 21.9 | 18.9 | 18.7 | 14.0 | 11.5 |
| 18 Pt. Rise Time (min) | 18.2 | 28.0 | 23.6 | 20.2 | 15.4 | 12.9 | 11.9 |
| Mooney | | | | | | | |
| Viscosity(ML₁₊₄ at | | | | | | | |
| 100° C. | | | | | | | |
| ML₁₊₄ | 44 | 45 | 43 | 43 | 42 | 42 | 42 |
| Stress Relaxation (%) | 93.4 | 92.8 | 92.8 | 93.2 | 92.9 | 92.4 | 92.4 |

It can be seen from the above data that the examples containing a high molecular weight thiuram disulfide and polyalkylene oxide as an activator (Examples 10-14) provide equivalent to improved performance when compared to the examples containing a low or high molecular weight thiuram disulfide with no polyalkylene oxide activator present therein (Comparative Examples E and F, respectively). For example, the cure rates were comparable or faster for Examples 10-14 than that of Comparative Examples E and F. Additionally, the scorch safety of the rubber compositions of the present invention was equivalent or improved resulting in an economical cost advantage being realized.

Although the invention has been described in its preferred form with a certain degree of particularity, obviously many changes and variations are possible therein and will be apparent to those skilled in the art after reading the foregoing description. It is therefore to be understood that the present invention may be presented otherwise than as specifically described herein without departing from the spirit and scope thereof.

What is claimed is:

1. A rubber composition comprising (a) a rubber component; (b) a carbon black filler; (c) a thiuram disulfide accelerator having a molecular weight of at least about 400 and (d) an effective amount of an activator for the thiuram disulfide accelerator.

2. The rubber composition of claim 1 wherein the rubber component is selected from the group consisting of natural rubber, homopolymers of conjugated diolefins, copolymers of conjugated diolefins and ethylenically unsaturated monomers and mixtures thereof.

3. The rubber composition of claim 1 wherein the rubber component is selected from the group consisting of natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, poly (acrylonitrile-butadiene) and ethylene-propylene-diene terpolymer.

4. The rubber composition of claim 1 wherein the carbon black filler is selected from the group consisting of furnace black, acetylene black, thermal black, channel black and mixtures thereof.

5. The rubber composition of claim 1 wherein the thiuram disulfide is of the general formula 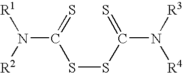
wherein R¹, R², R³ and R⁴ each are the same or different and are hydrocarbons containing from about 4 to about 30 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

6. The rubber composition of claim 5 wherein R¹, R², R³ and R⁴ each are the same or different and are hydrocarbons containing from about 8 to about 18 carbon atoms.

7. The rubber composition of claim 5 wherein R¹, R², R³ and R⁴ each are hydrocarbons of between about 12 and about 14 carbon atoms.

8. The rubber composition of claim 1 wherein the activator is one or more polyalkylene oxides.

9. The rubber composition of claim 8 wherein the polyalkylene oxide is selected from the group consisting of dimethylene glycol, diethylene glycol, dipropylene glycol, trimethylene glycol, triethylene glycol, tripropylene glycol, polyethylene oxide, polypropylene oxide and polybutylene oxide.

10. The rubber composition of claim 1 wherein the thiuram disulfide is of the general formula 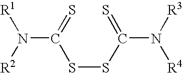
wherein R¹, R², R³ and R⁴ each are the same or different and are hydrocarbons containing from about 8 to about 18 carbon atoms and the activator is diethylene glycol.

11. The rubber compositions of claim 5 wherein R¹, R², R³ and R⁴ of the thiuram disulfide each are hydrocarbons of between about 12 and about 14 carbon atoms and the activator is diethylene glycol.

12. The rubber composition of claim 1 wherein the carbon black filler is present in an amount of from about 10 to about 100 phr, the thiuram disulfide is present in an amount of from about 0.05 to about 1 phr and the effective amount of the activator is from about 0.5 to about 10 phr.

13. The rubber composition of claim 10 wherein the carbon black filler is present in an amount of from about 30 to about 90 phr, the thiuram disulfide is present in an amount from about 0.1 to about 0.8 phr and the effective amount of diethylene glycol is from about 0.75 to about 5 phr.

14. The rubber composition of claim 1 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.

15. The rubber composition of claim 1 further comprising at least one other additive selected from the group consisting of vulcanizing agents, activators, fillers other than carbon black, retarders, antioxidants, plasticizing oils, and softeners, reinforcing pigments, antiozonants, waxes, tackifier resins and combinations thereof.

16. A method for making a rubber composition having an improved Mooney Scorch value which comprises the step of forming a rubber composition comprising (a) a rubber component; (b) a carbon black filler; (c) a thiuram disulfide accelerator having a molecular weight of at least about 400 and (d) an effective amount of an activator for the thiuram disulfide accelerator.

17. The method of claim 16 wherein the rubber component is selected from the group consisting of natural rubber, homopolymers of conjugated diolefins, copolymers of conjugated diolefins and ethylenically unsaturated monomers and mixtures thereof.

18. The method of claim 16 wherein the carbon black filler is selected from the group consisting of furnace black, acetylene black, thermal black, channel black and mixtures thereof.

19. The method of claim 16 wherein the thiuram disulfide is of the general formula 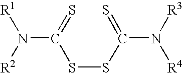
wherein R¹, R², R³ and R⁴ each are the same or different and are hydrocarbons containing from about 4 to about 30 carbon atoms, optionally containing one or more heterocyclic groups, or R¹ and R² and/or R³ and R⁴ together with the nitrogen atom to which they are bonded are joined together to form a heterocyclic group, optionally containing one or more additional heterocyclic atoms.

20. The method of claim 19 wherein R¹, R², R³ and R⁴ each are the same or different and are hydrocarbons containing from about 8 to about 18 carbon atoms.

21. The method of claim 19 wherein R¹, R², R³ and R⁴ each are hydrocarbons of between about 12 and about 14 carbon atoms.

22. The method of claim 16 wherein the activator is one or more polyalkylene oxides.

23. The method of claim 22 wherein the polyalkylene oxide is selected from the group consisting of dimethylene glycol, diethylene glycol, dipropylene glycol, trimethylene glycol, triethylene glycol, tripropylene glycol, polyethylene oxide, polypropylene oxide and polybutylene oxide.

24. The method of claim 16 wherein the thiuram disulfide is of the general formula 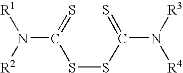
wherein R¹, R², R³ and R⁴ each are the same or different and are hydrocarbons containing from about 8 to about 18 carbon atoms and the activator is diethylene glycol.

25. The method of claim 19 wherein R¹, R², R³ and R⁴ of the thiuram disulfide each are hydrocarbons of between about 12 and about 14 carbon atoms and the activator is diethylene glycol.

26. The method of claim 16 wherein the carbon black filler is present in an amount of from about 10 to about 100 phr, the thiuram disulfide is present in an amount of from about 0.05 to about 1 phr and the effective amount of the activator is from about 0.5 to about 10 phr.

27. The method of claim 20 wherein the carbon black filler is present in an amount of from about 30 to about 90 phr, the thiuram disulfide is present in an amount from about 0.1 to about 0.8 and the effective amount of diethylene glycol is from about 0.75 to about 5 phr.

28. An article of manufacture comprising a rubber composition comprising (a) a rubber component; (b) a carbon black filler; (c) a thiuram disulfide accelerator having a molecular weight of at least about 400 and (d) an effective amount of an activator for the thiuram disulfide accelerator.

29. The article of manufacture of claim 28 wherein the thiuram disulfide is of the general formula 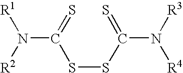
wherein R¹, R², R³ and R⁴ each are the same or different and are hydrocarbons containing from about 8 to about 18 carbon atoms.

30. The article of manufacture of claim 28 wherein the activator is one or more polyalkylene oxides selected from the group consisting of dimethylene glycol, diethylene glycol, dipropylene glycol, trimethylene glycol, triethylene glycol, tripropylene glycol, polyethylene oxide, polypropylene oxide, polybutylene oxide and mixtures thereof.

31. The article of manufacture of claim 29 wherein the activator is diethylene glycol.

32. The article of manufacture of claim 29 wherein R¹, R², R³ and R⁴ of the thiuram disulfide each are hydrocarbons of between about 12 and about 14 carbon atoms and the activator is diethylene glycol.

33. The article of manufacture of claim 28 which is a tire tread, motor mount, rubber bushing, power belt, printing roll, rubber shoe heel and sole, rubber floor tile, caster wheel, elastomer seal and gasket, conveyor belt cover, hard rubber battery case, automobile floor mat, truck mud flap, ball mill liner or windshield wiper blade.
